(19) United States
(12) Patent Application Publication
(10) Pub. No.: US 2011/0106935 A1
(43) Pub. Date: May 5, 2011

(54) POWER MANAGEMENT FOR IDLE SYSTEM IN CLUSTERS

(75) Inventor: VAIDYANATHAN SRINIVASAN, Bangalore (IN)

(73) Assignee: International Business Machines Corporation, Armonk, NY (US)

(21) Appl. No.: 12/608,203

(22) Filed: Oct. 29, 2009

(51) Int. Cl. G06F 15/173

(52) U.S. Cl. 709/224; 718/105

(57) ABSTRACT

Clusters of systems employed to increase computation capacity for specific services like the web or protocols such as the file transfer protocol. Broadly contemplated herein is an arrangement involving a set of compute nodes that perform the actual task and load balancer systems that monitor and distribute work among the compute nodes, taking into account the current load and remaining compute capacity available in each of the nodes. Power saving techniques can be applied to nodes in the cluster that are not actively running the workload due to lower utilization of the total cluster capacity.

### BACKGROUND

Current cluster monitoring techniques employ an agent or daemon program on each cluster node that periodically collects and transmits information to a load balancer. Such periodically running programs limit the scope of idle system power management.

Modern operating systems have sophisticated idle system power management capabilities that could well enable very low power consuming deep sleep states to the extent supported by underlying hardware. The low power consumption states are not limited to CPUs but could also be extend to memory and other IO devices or the entire system to the extend supported by hardware when there is no activity in the sub-component or the complete system in general. However, periodic polling activities in the compute node will affect the duration of the deep sleep states, thereby greatly reducing the power saving potential. On the other hand, employing a daemon program in the cluster node solely for the purpose of collecting and reporting utilization will degrade idle system power savings since the system must wake up from the low power deep sleep states to run the daemon. The periodicity of the polling activity would determine the choice of the sleep state, thereby reducing the power saving potential.

Network activity from each node can be observed and analyzed in order to determine the system utilization. However, such a scheme would not rely on a daemon to periodically collect utilization data from idle compute nodes, since an idle node can reside in low power deep sleep states and not generate any network traffic. Accordingly, a need has been recognized in connection with providing workable and power-efficient arrangements for idle system detection.

### SUMMARY

Broadly contemplated herein, in accordance with at least one embodiment of the invention, are arrangements for idle system detection and management by employing network monitoring techniques in cluster implementations.

Embodiments of the invention describes a method for monitoring utilization among nodes of a clustered system; balancing work loads among nodes of the clustered system based on the monitoring; the monitoring comprises monitoring an idle node; the monitoring of an idle node comprising avoiding wakeup of the idle node when there is no work request for the idle node.

Embodiments of the invention also describes an system, such as a data processing system or a computer system for performing network monitoring which monitors utilization among nodes of a clustered system; a load balancer which balances work loads among nodes of the clustered system based on monitoring by the network monitor; the network monitor acting to monitor an idle node via avoiding wakeup of the idle node when there is no work request of the idle node.

A further embodiment of the invention also provides a program storage device readable by machine, tangibly embodying a program of instructions executable by the machine to perform a method for monitoring utilization among nodes of a clustered system; balancing loads among nodes of the clustered system based on the monitoring; the monitoring comprises monitoring an idle node; the monitoring of an idle node comprising avoiding wakeup of the idle node when there is no work request of the idle node

For a better understanding of the embodiments of the invention, together with other and further features and advantages thereof, reference is made to the following description, taken in conjunction with the accompanying drawings, and the scope of embodiments of the invention will be pointed out in the appended claims.

### BRIEF DESCRIPTION OF THE DRAWINGS

Embodiments of the invention will best be understood by reference to the following detailed description of an illustrative embodiment when read in conjunction with the accompanying drawings, wherein like reference numerals indicate like components, and in the drawings:

FIG. 1 shows an exemplary embodiment of a computer system;

FIG. 2 illustrates an exemplary embodiment of a network including nodes and an arrangement for load balancing among the nodes;

### DETAILED DESCRIPTION

For a better understanding of the embodiments of the invention, together with other and further features and advantages thereof, reference is made to the following description, taken in conjunction with the accompanying drawings, and the scope of the invention will be pointed out in the appended claims.

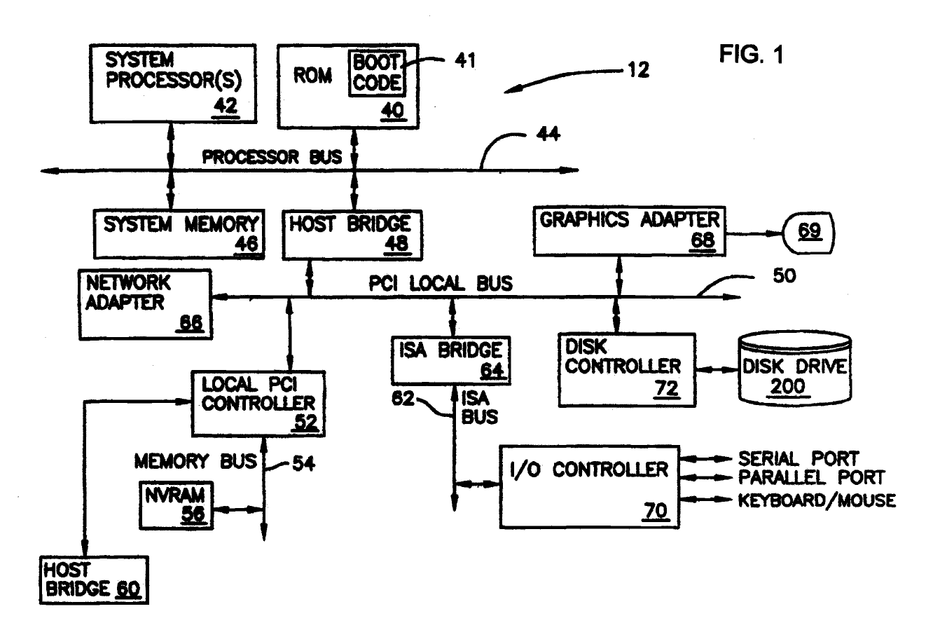

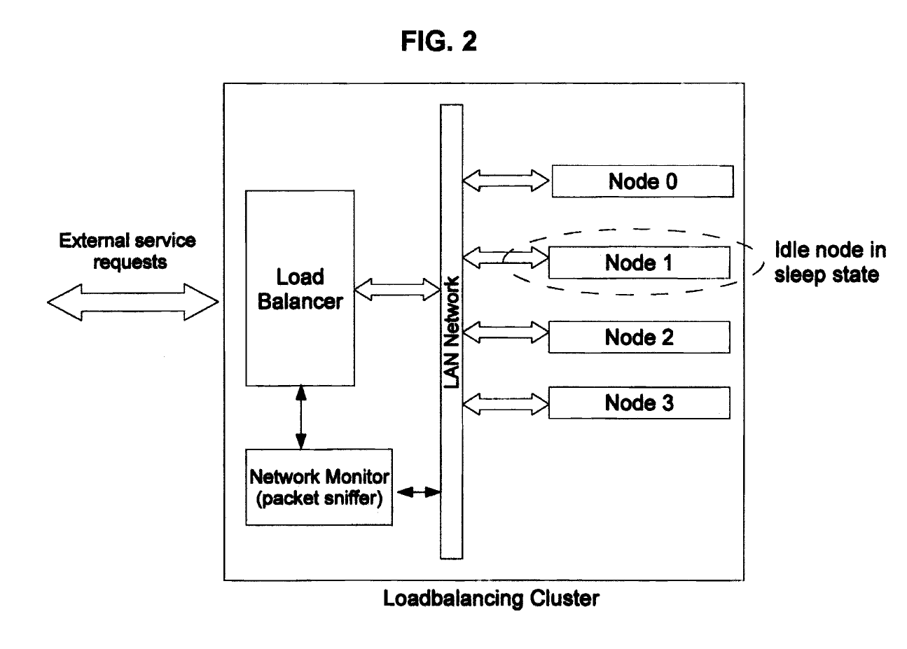

It will be readily understood that the components of the embodiments of the invention, as generally described and illustrated in the Figures herein, may be arranged and designed in a wide variety of different configurations. Thus, the following more detailed description of the embodiments of the apparatus, system, and method of the embodiments of the invention, as represented in FIGS. 1 through 2, is not intended to limit the scope of the invention, as claimed, but is merely representative of selected embodiments of the invention.

Reference throughout this specification to “one embodiment” or “an embodiment” (or the like) means that a particular feature, structure, or characteristic described in connection with the embodiment is included in at least one embodiment of the invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that embodiments of the invention can be practiced without one or more of the specific details, or with other methods, components, materials, etc. In other instances, well-known structures, materials, or operations are not shown or described in detail to avoid obscuring aspects of the embodiments of the invention.

The illustrated embodiments of the invention will be best understood by reference to the drawings, wherein like parts are designated by like numerals or other labels throughout. The following description is intended only by way of example, and simply illustrates certain selected embodiments of devices, systems, and processes that are consistent with the invention as claimed herein.

Reference is now made to FIG. 1, which illustrates an exemplary embodiment of a block diagram of an of a computer system 12, which may be employed in accordance with one or more embodiments of the present invention. It is to be understood that the system 12 shown in FIG. 1 is provided by way of an illustrative and non-restrictive example, and that other types of computer systems can be employed with the embodiments of the invention set forth herein. Generally, for example, while embodiments of the present invention could employ a cluster of laptops, it should also be noted that embodiments of the invention as described herein are particularly workable in the context of a cluster of enterprise server hardware.

The illustrative embodiment depicted in FIG. 1 may be a desktop computer, a notebook computer system, a pocket personal computer, a PDA, a mobile phone and the likes. However, as will become apparent from the following description, embodiments of the invention are applicable to any data processing system in general. Notebook computers may alternatively be referred to as “notebooks”, “laptops”, “laptop computers” or “mobile computers” herein, and these terms should be understood as being essentially interchangeable with one another.

As shown in FIG. 1, computer system 12 includes at least one system processor 42, which is coupled to a Read-Only Memory (ROM) 40 and a system memory 46 by a processor bus 44. System processor 42, which may comprise one of the AMD™ line of processors produced by AMD Corporation or a processor produced by Intel Corporation, is a general-purpose processor that executes boot code 41 stored within ROM 40 at power-on and thereafter processes data under the control of operating system and application software stored in system memory 46. System processor 42 is coupled via processor bus 44 and Host Bridge 48 to Peripheral Component Interconnect (PCI) local bus 50.

PCI local bus 50 supports the attachment of a number of devices, including adapters and bridges. Among these devices is network adapter 66, which interfaces computer system 12 to a LAN, and graphics adapter 68, which interfaces computer system 12 to display 69. Communication on PCI local bus 50 is governed by local PCI controller 52, which is in turn coupled to non-volatile random access memory (NVRAM) 56 via memory bus 54. Local PCI controller 52 can be coupled to additional buses and devices via a second host bridge 60.

Computer system 12 further includes Industry Standard Architecture (ISA) bus 62, which is coupled to PCI local bus 50 by ISA bridge 64. Coupled to ISA bus 62 is an input/output (I/O) controller 70, which controls communication between computer system 12 and attached peripheral devices such as a keyboard and mouse. In addition, I/O controller 70 supports external communication by computer system 12 via serial and parallel ports. A disk controller 72 is in communication with a disk drive 200. Of course, it should be appreciated that the system 12 may be built with different chip sets and a different bus structure, as well as with any other suitable substitute components, while providing comparable or analogous functions to those discussed above.

Generally speaking, load balancing clusters are a set of networked computers that distribute and share incoming workloads among nodes in the cluster. As shown schematically in FIG. 2, a cluster 202 includes nodes 204 (essentially any workable number, but four are shown here) corresponding to such networked computers. Each node 204 can correspond to essentially any suitable computer system, such as (but of course not limited to) that indicated at 12 in FIG. 1. Incoming workloads are indicated at 212.

Each of the cluster nodes 204 runs user space or kernel space tools to manage and monitor the cluster operation. In order to perform effective load balancing, a load balancer program 206 is normally provided which—via a network monitor 208 (e.g., operating via packet sniffing in a manner to be described more fully herebelow)—obtains information on a current load and on remaining capacity in various nodes of the system. These statistics are generally collected by the user space and kernel space programs that are part of the cluster infrastructure.

Some load balancing clusters like Linux Virtual Servers estimate load and capacity, based on connection statistics as observed from the load balancer system. There are other types of clusters like fail-over clusters, such as HPC (High Performance Computing) clusters where load balancing and idle system detection is not a prominent issue.

Speaking further in general terms, power management in computer systems has become important primarily because of increases in compute density, design factors like power efficiency, and increased use of computing systems in battery powered or power constrained environments.

Laptop systems are a typical example where power efficiency and system power management play a critical role. Recent advances in hardware technology have enabled processors and other system components to quickly switch to low power consuming deep sleep states. Apart from various sleep states, processors can also operate at different frequencies where their power consumption can be matched with the required compute capacity.

When a system is idle, the operating system can detect the utilization and transit the system to lower power consuming frequencies and also exploit the deep sleep states. However, periodic housekeeping jobs in the system typically have to execute even while there is no significant workload. These periodic spurts of housekeeping work results in the processor waking up from sleep states and executing instructions and then quickly returning to sleep states.

The periodicity of these wakeups greatly limits the extent to which low power deep sleep states can be exploited by the software. If all of these periodic housekeeping can be moved to asynchronous or deferred work that can be bunched together at a later time, then the processor can sleep for a longer duration and would experience fewer wakeups. Thus, extending the sleep time of an idle processor and also allowing deeper sleep states would yield substantial power savings.

New techniques in operating systems can reduce periodic timer interrupts drastically. However, in these cases the operating system is limited by the user-space application behavior. Periodic polling daemons and other user space programs that do housekeeping tasks can affect idle system power management, even if they do not significantly present problems for non-idle systems where the processor is busy and does not transit to sleep states.

Generally, user space applications and daemons that perform polling or periodic housekeeping tasks like collecting statistics are detrimental to idle system power management.

Operating systems have traditionally avoided polling for reasons of performance. Sophisticated event notifications and interrupts help operating systems to reduce periodic burst of tasks in an idle system. Some of the housekeeping jobs like time keeping and scheduler related data are also being deferred and bunched together to enable processors to sleep for longer duration and save power.

However, any periodic activity from user space would still wake up the processors from the sleep states. Hence, there is a need to avoid and reduce user space polling and housekeeping at least in an idle system. If a user space daemon is used periodically to check system utilization, then there will be periodic processor wake ups that would greatly reduce the ability of the system to transit to lower power deep sleep states.

Current techniques used to estimate cluster node utilization are based on user space or kernel space code that would collect and report utilization and provide feedback to the load balancer program.

Embodiments of the invention generally seek to avoid those issues that would be encountered with running a daemon to collect system idleness data, since this places an unduly drain on system resources. Accordingly, as broadly contemplated herein in accordance with at least one embodiment of the present invention, a daemon or periodic code normally employed to collect system utilization information or data may be stopped, or simply not be employed in the first place, with respect to an idle system. Consequently, processors will be able to remain in a deep sleep state until real work arrives for the idle node in question, thus obviating the need to “wake up” the node simply for the purpose of that node providing data. Accordingly, a combination of network monitoring and polling in the cluster nodes may be employed such that—in obviating the need to employ a daemon or periodic code—idle system power management becomes a much more efficient and cost-effective endeavor.

As such, it will generally be appreciated that clustered systems 202 use network infrastructure, such as a LAN network 210, to communicate among nodes 204 and the load balancer 206. The load balancer system 206 (or even an independent system on the same cluster network) can observe the network traffic in the cluster 202 to determine the utilization of the cluster 202.

Packet sniffing techniques normally can be employed by network monitor 208 to observe all the network traffic in the cluster 202 in aggregate and thereby estimate the utilization of the cluster nodes 204, without needing to poll individual nodes, while also inspecting packet content. Idle nodes (such as “Node 1” in the Figure) of course do not participate in any network activity. Thus, as long as packet sniffing techniques are used to generally estimate utilization among cluster nodes, there is no need to individually poll an idle node for such information, especially since there is no activity emanating from an idle node at such times anyway. However, to the extent that new jobs can still be sent at any point to an idle system such as “Node 1”, the node at that point will of course wake up from its sleep state and start processing the workload.

Accordingly, then, accurate utilization data of the formerly idle node can be collected and sent to the load balancer 206; this can be done as soon as the idle node “wakes up” from its sleep state. Thus, the idle node need only provide accurate utilization data when it is woken up anew in accordance with an actual work request, rather than temporarily (and/or periodically) waking up in response to a much more minor stimulus such as a daemon or periodic code. Accordingly, the waste of system resources inherent in waking up to minor stimuli is avoided.

Network packet sniffing techniques are already used in cluster implementation for failure detection and other security related functions like intrusion detection. Accordingly, the inventive technique just discussed essentially is an extension of the same concept for system idle detection, whereby periodic housekeeping tasks for the node can be avoided or obviated at times when the node is asleep. Generally, it should be noted that a network packet sniffing technique in accordance with embodiments of the invention can afford the capability of examining the content of a network packet and modeling the type of request being processed by a node, as in a case where a node is non-idle while having no current network activity.

It should thus be appreciated that solutions, in accordance with at least one embodiment of the invention, make use of existing cluster infrastructure and software techniques for a different purpose. Network packet sniffing in a cluster for the purpose of system idle detection and consequently improving idle system power management is indeed a novel technique.

By way of further elaboration, a daemon can be started after a cluster wakes up and stopped when there is no work and a communication can be sent to activate or deactivate network monitoring. In other words, there can be communication and coordination from the daemon based utilization monitor and network based utilization monitor. The former is good for an accurate estimate when the node is not idle while the latter is appropriate when the node is idle. Communication between the two entities can ensure that network monitoring is used when the node is idle or near idle and stop the polling daemon; at the same time, the reverse can be done (i.e., use the polling daemon and stop network monitoring) when the node is highly utilized and network monitoring technique is not accurate.

It can also be noted that switching between the two techniques (daemon-based polling and network monitoring) mentioned above can serve to circumvent disadvantages of network monitoring (e.g., accuracy and overhead) when power savings is not a concern.

It is to be understood that embodiments of the invention, includes elements that may be implemented on at least one general-purpose computer running suitable software programs. These may also be implemented on at least one Integrated Circuit or part of at least one Integrated Circuit. Thus, it is to be understood that the invention may be implemented in hardware, software, or a combination of both.

Generally, embodiments may take the form of an entirely hardware embodiment, an entirely software embodiment or an embodiment containing both hardware and software elements. An embodiment that is implemented in software may include, but is not limited to, firmware, resident software, microcode, etc.

Furthermore, embodiments may take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system, (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-RAN) and DVD.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

Embodiments of the invention have been presented for purposes of illustration and description but are not intended to be exhaustive or limiting. Many modifications and variations will be apparent to those of ordinary skill in the art. The embodiments were chosen and described in order to explain principles and practical application, and to enable others of ordinary skill in the art to understand the disclosure for various embodiments with various modifications as are suited to the particular use contemplated.

The foregoing describes only some embodiments of the invention, and modifications and/or changes can be made thereto without departing from the scope and spirit of the embodiments of the invention, and the embodiments being illustrative and not restrictive

As will be readily apparent to a person skilled in the art, embodiments of the invention can be realized in hardware, software, or a combination of hardware and software. Any kind of computer/server system(s)—or other apparatus adapted for carrying out the methods described herein—is suited. A typical combination of hardware and software could be a general-purpose computer system with a computer program that, when loaded and executed, carries out the respective methods described herein. Alternatively, a specific use computer, containing specialized hardware for carrying out one or more of the functional tasks of the invention, could be utilized.

Aspects of the invention, can also be embodied in a computer program product, which comprises all the respective features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

Generally, although illustrative embodiments of the invention have been described herein with reference to the accompanying drawings, it is to be understood that the invention is not limited to those precise embodiments

What is claimed is:

1. A method power management in a clustered system, the method comprising:
monitoring utilization among nodes of the clustered system;
balancing work loads among nodes of the clustered system based on the utilization monitoring, wherein the utilization monitoring comprises monitoring an idle node; and
avoiding activation of the idle node when there is no work request of the idle node based on the utilization monitoring of the idle node.

2. The method as claimed in claim 1, wherein the utilization monitoring comprises obtaining utilization information of the idle node solely when work is requested of the idle node.

3. The method as claimed in claim 1, wherein the utilization monitoring comprises packet sniffing for general node utilization information.

4. The method as claimed in claim 3, wherein said packet sniffing comprises
examining network packet content; and
modeling a request being processed by a node.

5. The method as claimed in claim 1, wherein the step of avoiding activation comprises avoiding individual polling of the idle node when there is no work request of the idle node.

6. The method as claimed in claim 5, wherein the step of avoiding individual polling comprises avoiding daemon-based polling of the idle node when there is no work request of the idle node.

7. The method as claimed in claim 5, wherein the step of avoiding individual polling comprises avoiding periodic polling of the idle node when there is no work request of the idle node.

8. A data processing system comprising at least a processor and a memory, further comprising a network monitor which monitors utilization among nodes of a clustered system; a load balancer which balances work loads among nodes of the clustered system based on monitoring by the network monitor; and the network monitor configured to monitor an idle node by avoiding activation of the idle node when there is no work request of the idle node.

9. The system as claimed in claim 8, wherein the network monitor is configured to obtain utilization information of the idle node solely when work is requested of the idle node.

10. The system as claimed in claim 8, wherein the network monitor is configured to employ packet sniffing for general node utilization information.

11. The system as claimed in claim 10, wherein the network monitor is configured to examine network packet content and model a request being processed by a node.

12. The system as claimed in claim 8, wherein the network monitor is configured to avoid individual polling of the idle node when there is no work request of the idle node.

13. The system as claimed in claim 12, wherein the network monitor is configured to avoid daemon-based polling of the idle node when there is no work request of the idle node.

14. The system as claimed in claim 12, wherein the network monitor is configured to avoid periodic polling of the idle node when there is no work request of the idle node.

15. A program storage device readable by machine, tangibly embodying a program of instructions executable by the machine, the program of instructions when executed on the machine is capable of performing the steps of:
monitoring utilization among nodes of a clustered system;
balancing loads among nodes of the clustered system based on the utilization monitoring, wherein the utilization monitoring comprises monitoring an idle node; and
avoiding activation of the idle node when there is no work request of the idle node based on the utilization monitoring of an idle node.

16. The program storage device as claimed in claim 15, wherein the utilization monitoring comprises obtaining utilization information of the idle node solely when work is requested of the idle node.

17. The program storage device as claimed in claim 15, wherein the utilization monitoring comprises packet sniffing for general node utilization information.

18. The program storage device as claimed in claim 15, wherein the step of avoiding activation comprises avoiding individual polling of the idle node when there is no work request of the idle node.

19. The program storage device according to claim 18, wherein the step of avoiding individual polling comprises avoiding daemon-based polling of the idle node when there is no work request of the idle node.

20. The program storage device as claimed in claim 18, wherein the step of avoiding individual polling comprises avoiding periodic polling of the idle node when there is no work request of the idle node.
